(19) United States
(12) Patent Application Publication
(10) Pub. No.: US 2006/0227458 A1
(43) Pub. Date: Oct. 12, 2006

(54) Corrosion inhibitors and methods for magnetic media and magnetic head read-write device

(75) Inventor: Donald C. Zipperian, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(73) Assignee: Pace Technologies Corporation, Tucson, AZ (US)

(21) Appl. No.: 11/102,905

(22) Filed: Apr. 8, 2005

(51) Int. Cl. G11B 5/10

(52) U.S. Cl. 360/128

(57) ABSTRACT

Corrosion inhibitor compositions and methods useful in finishing, grinding, cleaning, and other operations involving materials used in the manufacture of magnetic reading/writing heads and magnetic storage media. The compositions contain at least one azole compound, are soluble in ethylene glycol, propylene glycol, glycerin and isopropyl alcohol, and provide corrosion resistance for magnetic metals, such as manganese, iron, nickel, and cobalt, as well as magnetic alloys and magnetic layered stacks containing manganese, iron, nickel, cobalt, chromium, iridium, ruthenium, zirconium, and tantalum.

### BACKGROUND OF THE INVENTION

1. Field of the Invention

The present invention relates to the field of corrosion inhibitor compositions and corrosion reduction processes. More particularly, the present invention relates to non-aqueous and aqueous compositions especially useful in methods for controlling corrosion during manufacturing operations, such as polishing, grinding, cutting, lapping and cleaning, of magnetic materials and thin film magnetic layers present in magnetic head read-write devices and magnetic media.

2. Description of the Related Art

Recording and reading data on a computer hard drive is accomplished by converting electricity to magnetism and vice versa. Presently, computer hard drives are produced by thin film deposition and metal plating processes. The magnetic recording heads use inductive coils for writing data and magnetoresistive elements for reading the data. The inductive writing element is an electromagnet. Data writing is accomplished by applying an electric current to the inductive write element, whereby an electric field is produced. When an area of the media disk is exposed to the magnetic field at the tips of the inductive element, it becomes magnetized, and data is written to it. The data will remain as written until changed by a later write operation. Each independent area, called a bit, can have one of two states (a “1” or a “0”). This state is defined by the direction of the magnetization. The inductive magnetic pole materials are often made of nickel, iron and cobalt metals.

Data is read off the disk using magnetoresistive (MR) elements or even more sensitive giant magnetoresistive (GMR or spin valve), colossal magnetoresistive (CMR) or tunneling magnetoresistive (TMR) elements. A magnetoresistive material has an electrical resistance which will change if a magnetic field is applied to it. Magnetic data can be read by monitoring the resistance of the magnetoresistive material. MR, GMR, CMR and TMR elements are multiple layer sandwich structures with very thin layers consisting of metallic or alloy combinations of iron, manganese, cobalt, nickel, cobalt, tantalum, iridium, ruthenium, zirconium, platinum and copper.

To achieve the tunnel magnetoresistance (TMR) effect, multilayered films are deposited so that there is a tunnel barrier layer, a ferromagnetic free layer and a ferromagnetic pinned layer. In addition to the layer materials described above, these film layers also may consist of very exotic combination of magnetic and non-magnetic materials (e.g., Co/Al2O3/NiFe, SrFeMoO, Fe/Al2O3/Fe50Co50, La0.67Sr0.33MnO3/SiTiO3/La0.67Sr0.33MnO3, GaMnAs/AlAs/GaMnAs, Fe—O/AlOx/NiFe—O).

Corrosion protection related to magnetic hard drive heads have been limited to the back-end processing, whereby a thin diamond-like carbon (DLC) coating is sputtered onto the magnetic head. In-line processing for eliminating corrosion at the cutting, lapping, transfer, and cleaning operations are minimal and involve inspection in rejecting affected heads rather than corrosion prevention or reduction. As a first pass, optical inspection has been used to discard corroded heads. In addition, electrical and magnetic testing eliminates the heads affected by corrosion of the MR, GMR, CMR or TMR elements.

For years, inorganic chemicals, such as the heavy metals chromate and molybdate or nitrite-containing corrosion inhibitors, have typically been used in closed water systems for metal corrosion protection. When chromate was banned from use in many recirculating cooling water systems and regulations were enacted restricting the discharge of other inorganic chemicals, interest developed in using corrosion inhibitor formulations containing only organic chemicals for closed cooling water systems.

For example, U.S. Pat. No. 6,403,028 discloses the use of 6,6′,6″-(1,3,5-triazine-2,4,6-triyltriimino)tris hexanoic acid and water-soluble phosphonated oligomer salts in a closed water system. These corrosion inhibiting compositions are particularly effective at inhibiting the corrosion of metal surfaces made of mild steel, where steel is found alone in the components of the cooling system or where there are components present made of other metals, such as brass, copper, and aluminum.

U.S. Patent Application 2005/0023506 discloses corrosion inhibitors used in cooling water systems using low hardness water, particularly a specific monocarboxylic acid with even-numbered carbon atoms and sebacic acid as a corrosion inhibitor.

Alternatively, a specific aliphatic monocarboxylic acid and sebacic acid are blended with a specific aliphatic oxycarboxylic acid and a specific polycarboxylic acid to prepare a corrosion inhibitor. This patent application further relates to corrosion inhibitors and corrosion control, or corrosion-proofing, methods for metals in water systems, and particularly to organic corrosion inhibitors and corrosion control methods, whereby corrosion of ferrous metal and nonferrous metal members can be effectively prevented even in highly corrosive cooling water having a low hardness (at most 200 mg as CaCO₃/liter in total hardness).

While the invention of U.S. Patent Application 2005/0023506 is applied mainly in the field of cooling water treatment systems, it can also be applied to wastewater treatment systems, industrial water treatment systems, and deionized water production systems. The application also teaches the use of an azole compound as a corrosion inhibitor for cupreous metals, such as copper and copper alloys, and is preferably further used or blended with the indispensable ingredients of the organic corrosion inhibitor of this invention as described above. Examples of the azole compound include benzotriazole, tolyltriazole, and aminotriazole.

U.S. Patent Application 2002/0031985 discloses the use of azole compounds to affect the planarization control for chemical mechanical polishing particularly of copper. The polishing composition includes an oxidizer capable of oxidizing a metal undergoing planarization and yielding a complexing agent that complexes with the oxidized metal and a stabilizer such as a stannate salt. The composition may further include abrasive particles and/or various azoles, such as benzotriazole, imidazole, benzimidazole, benzothiazole, mercaptobenzotriaole, 5-methyl-1-benzotriazole, and combinations thereof. In practice, this composition typically is used in a multi-step polishing process that includes polishing a substrate surface to selectively remove a metal layer with respect to a barrier layer and dielectric layer and polishing a substrate surface using the composition to non-selectively remove the metal layer, a barrier layer, and a dielectric layer from the substrate surface.

U.S. Pat. No. 6,811,680 discloses a method for processing a substrate that includes the steps of (1) positioning the substrate in an electrolyte solution containing a corrosion inhibitor adjacent to the polishing article, a leveling agent, a viscous forming agent, or combinations thereof to form a current suppressing layer on a substrate surface, (2) polishing the substrate in the electrolyte solution with the polishing article to remove at least a portion of the current suppressing layer, (3) applying a bias between an anode and a cathode disposed in the electrolyte solution, and (4) removing material from at least a portion of the substrate surface with anodic dissolution.

U.S. Pat. No. 6,554,878 discloses a slurry for polishing magnetic head assemblies to a common plane without the use of corrosion inhibitors.

While each invention above may be suitable for its intended purpose, there remains a need for new and improved compositions and methods for reducing and preventing corrosion of magnetic read-write head assemblies and magnetic media having complex metal and corresponding galvanic potential arrangements.

### SUMMARY OF THE INVENTION

The invention generally relates to compositions and methods involving the control of corrosion in thin film layers. More specifically, the invention involves compositions and methods for controlling corrosion of magnetic metals disposed upon read-write heads and other magnetic media through the use of an effective amount of at least one azole compound.

The complex combination of the metals which are deposited on each other to make the magnetoresistive magnetic stack material produces a very unique galvanic corrosion potential, and, therefore, it is difficult to predict, a priori, what the effect of adding an inhibitor would be. The invention overcomes this difficulty by providing new and improved methods and compositions for inhibiting corrosion of the metals found in thin film layers, and particularly the magnetic metals and alloys containing iron, nickel, manganese and cobalt, in magnetic head read-write devices and magnetic media.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### BRIEF DESCRIPTION OF THE DRAWINGS

FIG. 1 schematically illustrates the prior art GMR sensor metal layers on a typical magnetic head read-write device.

FIG. 2 depicts the galvanic oxidation potentials for several metals commonly found in magnetic head read-write devices and magnetic media.

FIGS. 3A-3K are Pourbaix Diagrams for several common metals that may corrode in distilled water environments.

FIGS. 4A and 4B are charts of test data demonstrating the effects with and without an inhibitor composition of the invention for manganese.

FIGS. 4C and 4D are charts of test data demonstrating the effects with and without an inhibitor composition of the invention for cobalt.

FIGS. 4E and 4F are charts of test data demonstrating the effects with and without an inhibitor composition of the invention for iron.

FIGS. 4G and 4H are charts of test data demonstrating the effects with and without an inhibitor composition of the invention for nickel.

FIG. 5 is a table showing the reduction in GMR corrosion rates with and without an inhibitor composition of the invention for iron, manganese, cobalt, copper, and nickel.

FIG. 6 is a table qualitatively summarizing the corrosion of the listed metals with and without an inhibitor composition of the invention.

FIG. 7 is a flowchart that outlines the steps involved in magnetic head manufacturing.

FIG. 8 is a flowchart summarizing the steps involved in preparing cutting or lapping lubricants and cleaning compositions according to the invention.

FIG. 9 is a schematic plan view of a magnetic head read-write device and magnetic media disc.

FIG. 10 is a schematic illustration of the bottom surface (i.e., the surface facing the disk) of the magnetic head 30 shown in FIG. 9.

### DETAILED DESCRIPTION OF THE PREFERRED EMBODIMENTS

In one aspect, the invention relates generally to compositions and processes that involve preventing or inhibiting corrosion associated with the manufacturing of magnetic head read-write devices by using effective amounts of an organic corrosion inhibitor, such as an azole compound. Moreover, the present invention may be applied to a wide variety of magnetic media in order to prevent or reduce corrosion-related deterioration, including, but not limited to, hard drives heads, media disks, tape drive heads, MRAM memory, and the like.

Previously, a composition including an azole only has been used for corrosion inhibition in non-magnetic closed water systems and with copper planarization in the semiconductor industry. However, this use of azoles is for controlling grinding rates by what is know as chemical mechanical polishing (CMP). Indeed, since it is involved in the polishing of metal layers, the azole compound is removed before manufacturing is finished. In contrast, the present invention relates to ongoing corrosion protection during processing and after assembly and is not focused on planarization.

Magnetic read-write sensor metals are very susceptible to a number of forms of electrochemical corrosion. Today's GMR stacks include various combinations of iron, nickel, manganese, tantalum, indium, copper, chromium, ruthenium, zirconium, and cobalt. The thickness of these metals typically range from about 1 nm up to 20-30 nm, but can be as thick as 100 nm. The magnetoresitive write metals and inductive writing head alloys are also susceptible to corrosion from the lapping slurries, lubricant, cut-rate enhancers and cleaning agents.

Many of these metals are very reactive in distilled water and with the lapping lubricants used for machining the magnetic heads to the final sensor height dimensions. Although the most widely used lapping lubricants are either oil-based or glycol-based lubes, they typically still contain some sort of water-based cut rate enhancers, surfactants, or are mixed with water.

Magnetic hard drive areal densities continue to double every 9 months. This trend continues to strain the production and development of magnetic read-write head manufacturing processes. In addition, as the thickness of the magnetic thin film layers continues to decrease and the alloy composition becomes more complex, the relationship between GMR or TMR spin valves magnetic properties and its susceptibility to corrosion continues to merge.

From a quantum mechanics perspective, the relationship between magnetism and corrosion are both related to the flow of electrons. Thus, controlling the GMR or TMR phenomenon is directly related to the factors which also lead to corrosion (i.e., the flow of electrons).

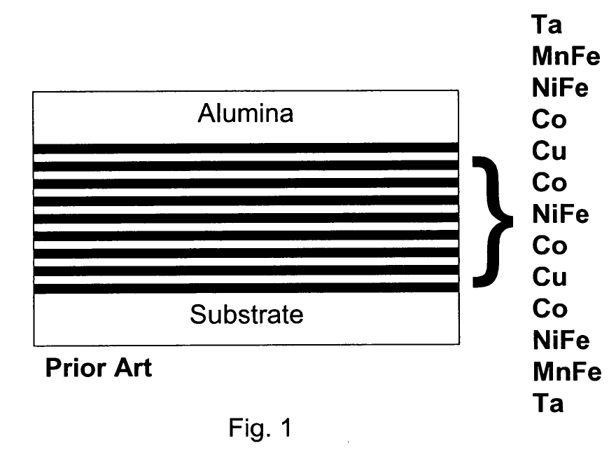

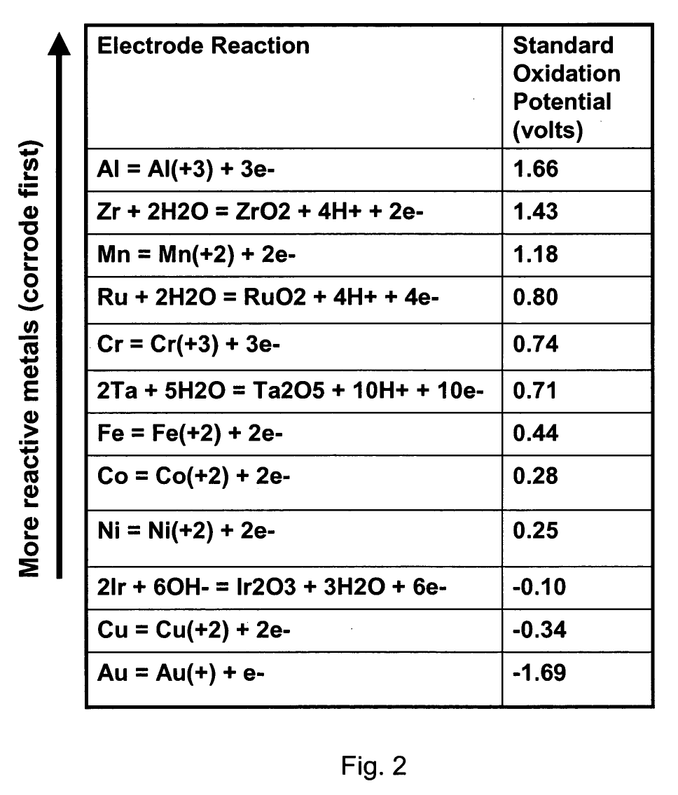

The MR, GMR, CMR, and TMR sensors continue to become more complicated as more and thinner layers are incorporated into the stack. FIG. 1 is a schematic illustration of the types of metals being engineered into today's GMR devices. The type and number of these materials offers a plethora of opportunities for galvanic and electrolytic corrosion. Galvanic corrosion occurs when two metals having different oxidation potentials contact each other in a conductive solution. FIG. 2 shows the galvanic series for the common metals used in the MR, GMR, CMR and TMR stacks. The more positive oxidation potentials will corrode preferentially to the more noble or lower oxidation potential metals.

Although galvanic corrosion can be an issue, the more predominate corrosion issue occurs when the same metallic surfaces are exposed to aqueous or non-aqueous electrolyte solvent solutions. This mechanism occurs as the anodic reaction or dissolution of the metal occurs with the reduction of the solvent (water or organic). While the mechanism of organic corrosion has not been studied to any significant degree, the cathodic reactions for aqueous solutions are well understood. Typically, cathodic reactions include the reduction of dissolved oxygen gas, or the reduction of water to produce hydrogen gas. The later is driven by the solution pH.

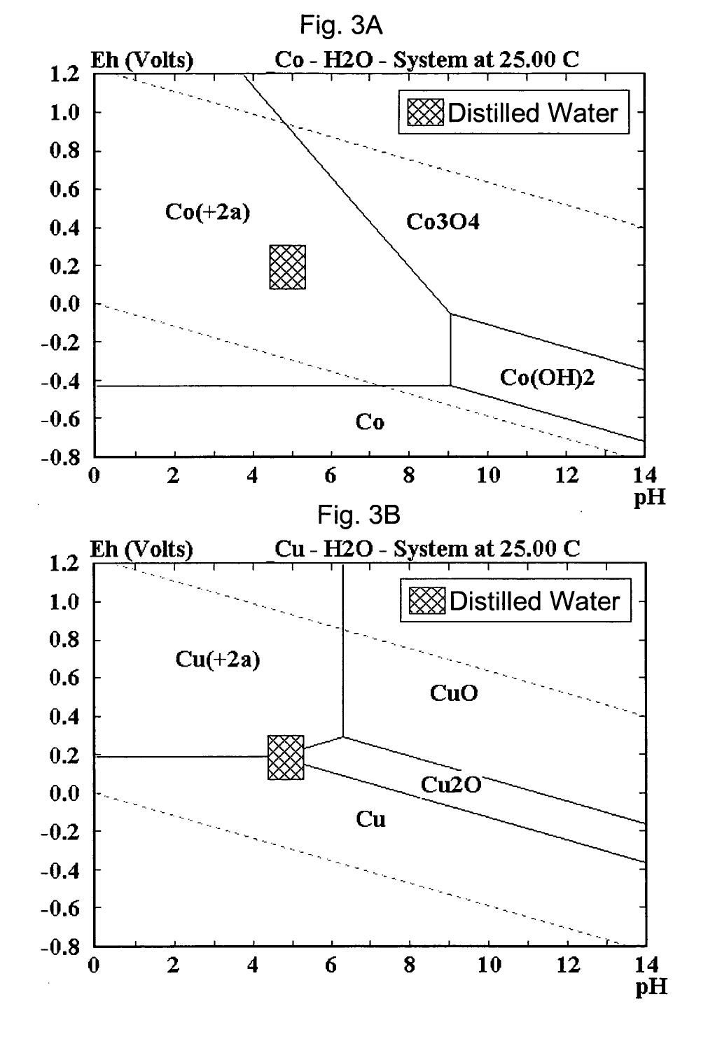

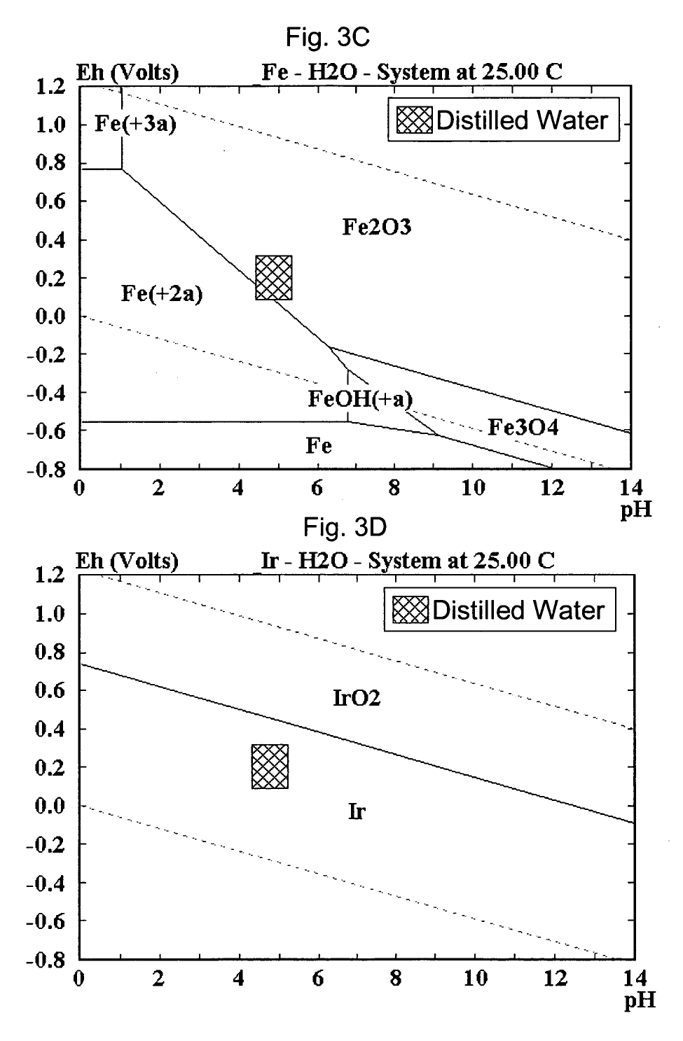

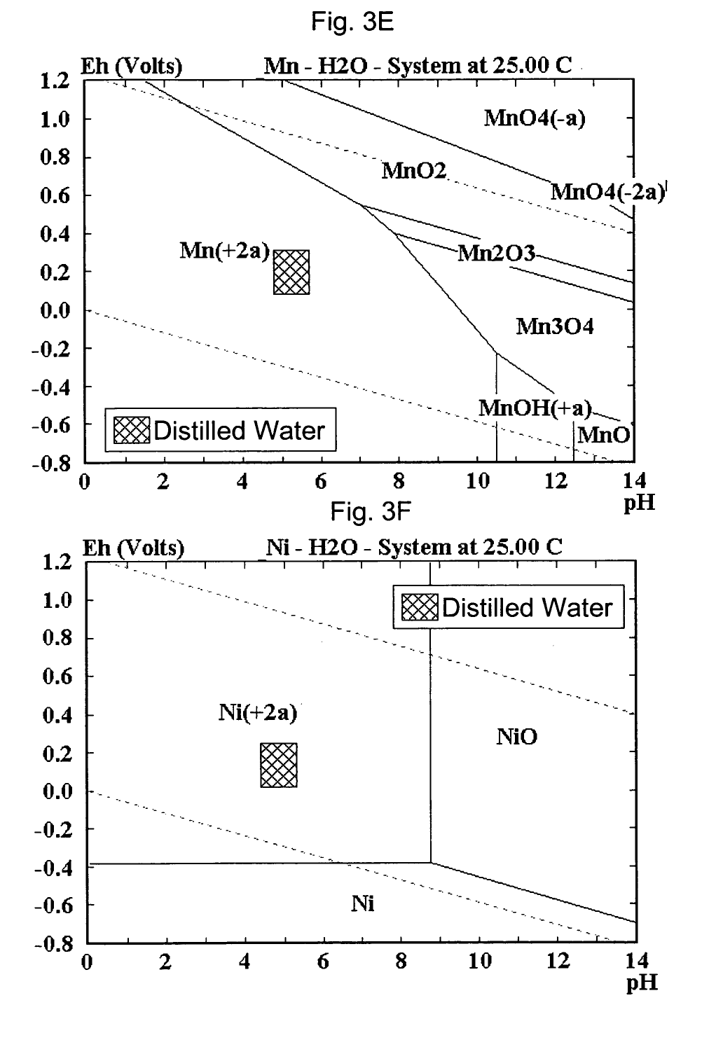

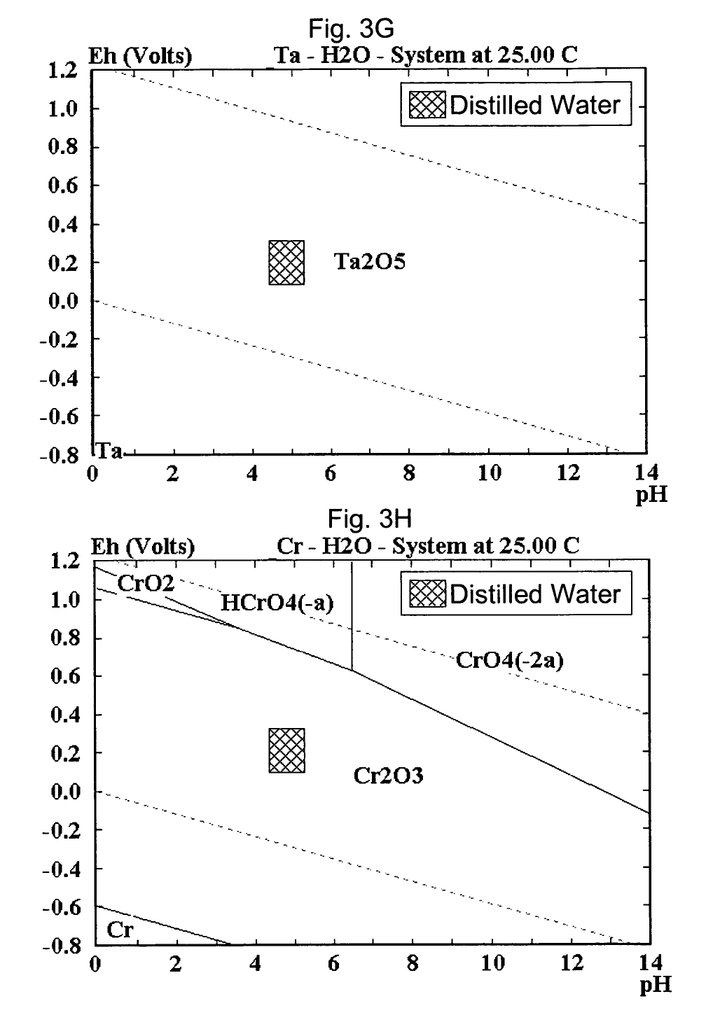

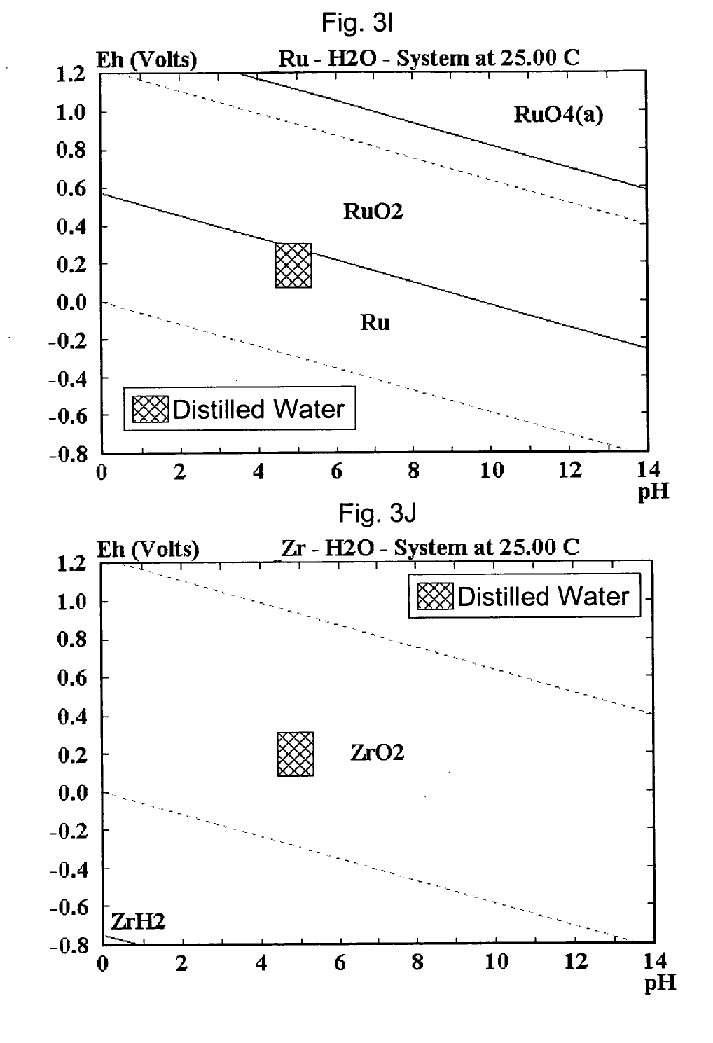

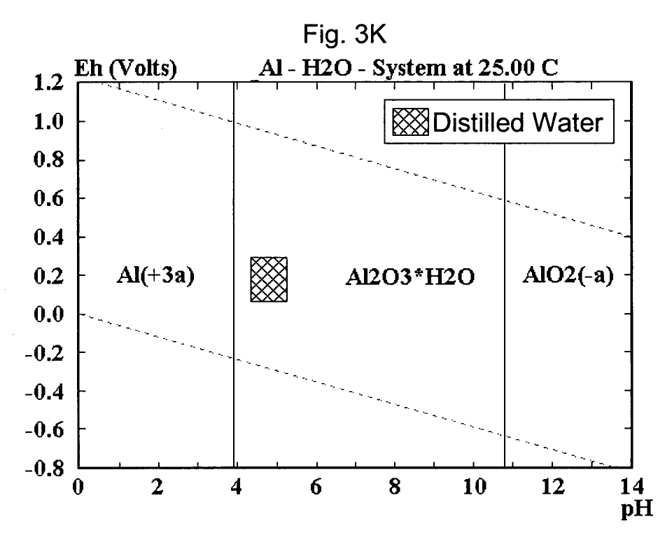

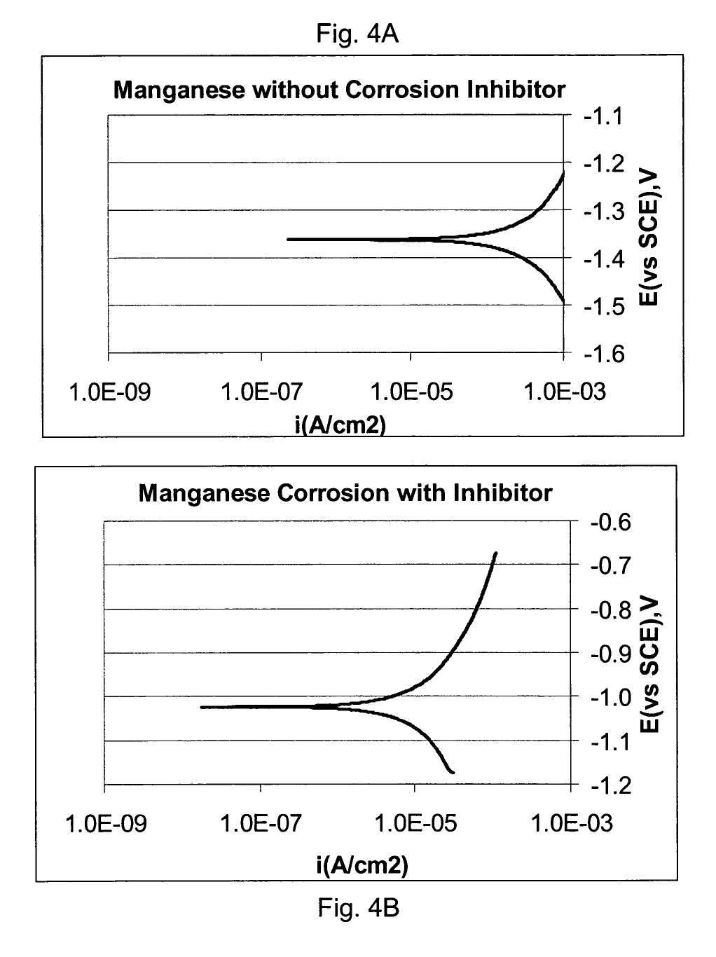

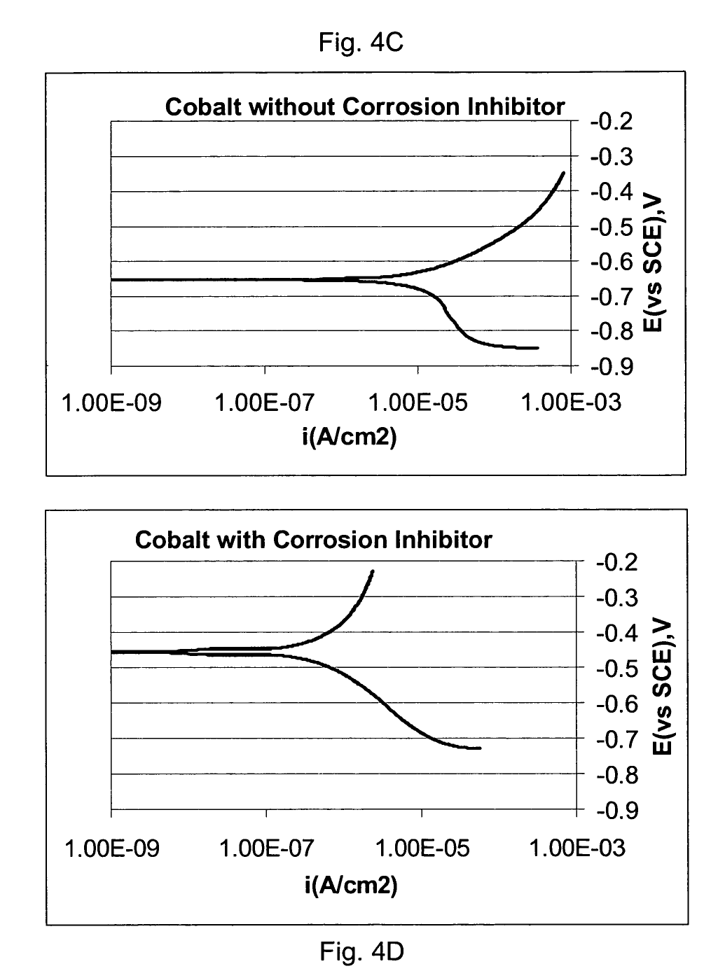

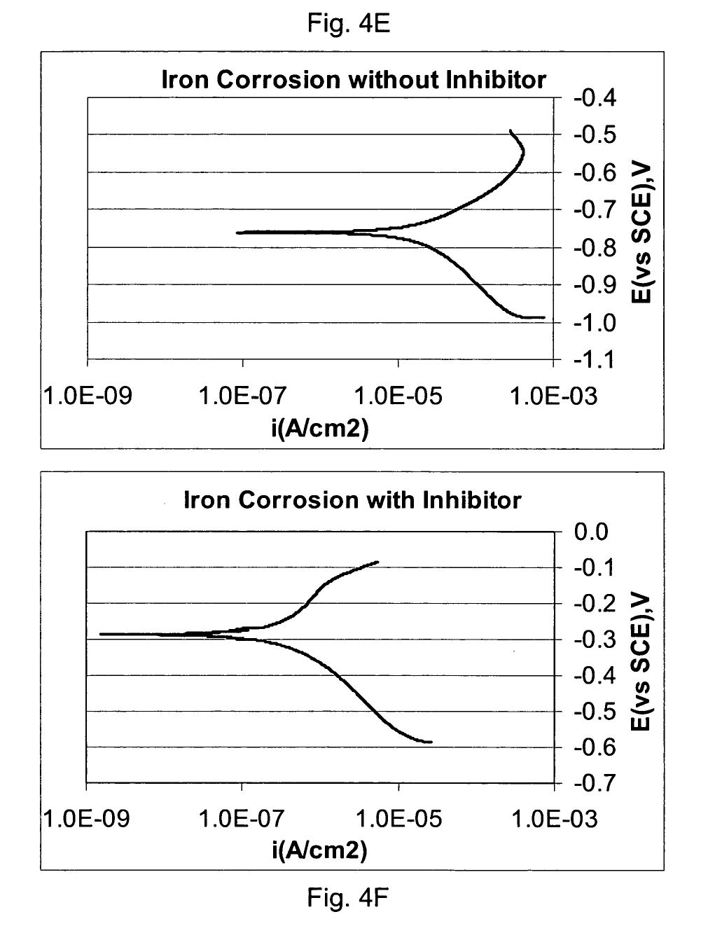

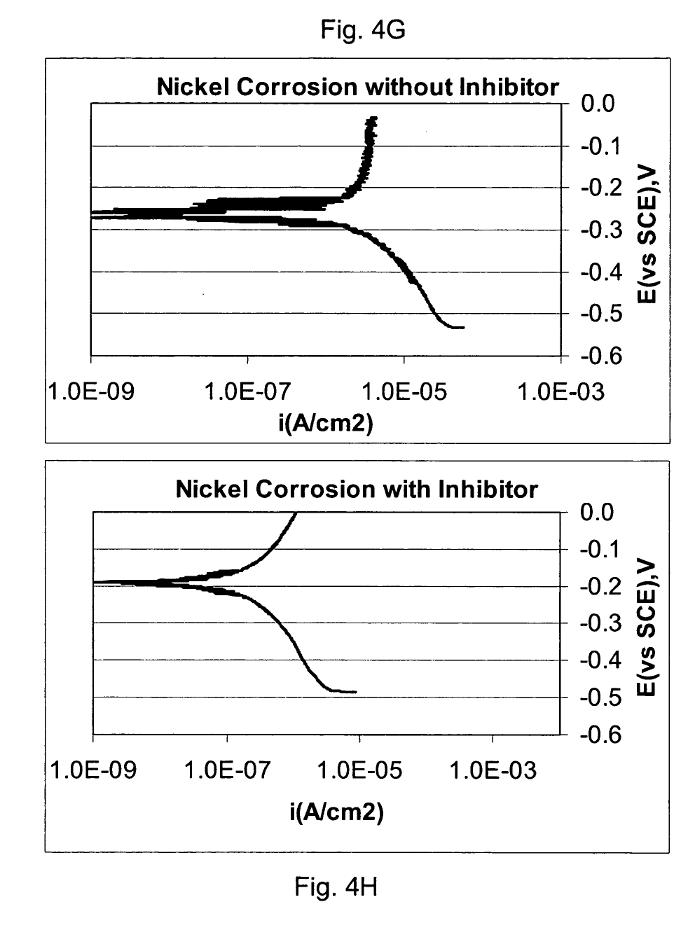

A useful way to study the relation of potential to corrosion is with an electrochemical equilibrium diagram—called the Pourbaix Diagram. Pourbaix Diagrams are thermodynamic plots of potential vs. pH (see FIGS. 3A-3K of sample Pourbaix Diagrams for metals commonly found in magnetic head read-write devices). Corrosion rates are determined by applying a current to produce a polarization curve (the degree of potential change as a function of the amount of current applied) for the metal surface whose corrosion rate is being determined. The most common technique for determining the corrosion rate is based on the Tafel equation. FIG. 4A shows the polarization curve for manganese without a corrosion inhibitor and FIG. 4B shows the polarization potential for manganese with an organic corrosion inhibitor of the invention. Similarly, FIG. 4C shows the polarization curve for cobalt without a corrosion inhibitor and FIG. 4D shows the polarization potential for cobalt with a corrosion inhibitor of the invention. FIGS. 4E-4H show the polarization curve data for iron and nickel, respectively, both with and without a corrosion inhibitor of the invention.

Based on the Tafel plots (FIGS. 4A-4B), the corrosion rate for manganese without the corrosion inhibitor is 147 angstroms per minute vs. 5 angstroms per minute using an organic corrosion inhibitor. For cobalt, the corrosion rate decreased from 1.76 angstroms per minute without the corrosion inhibitor to 0.015 Angstoms per minute with the corrosion inhibitor (see FIGS. 4C-4D). FIGS. 4E-4F show the corrosion rate for iron is decreased from 7.35 angstroms per minute to 0.55 angstroms. Likewise, the corrosion rate for nickel (see FIGS. 4G-4H) is decreased from 1.33 angstroms per minute to 0.020 angstroms per minute with the use of the corrosion inhibitor.

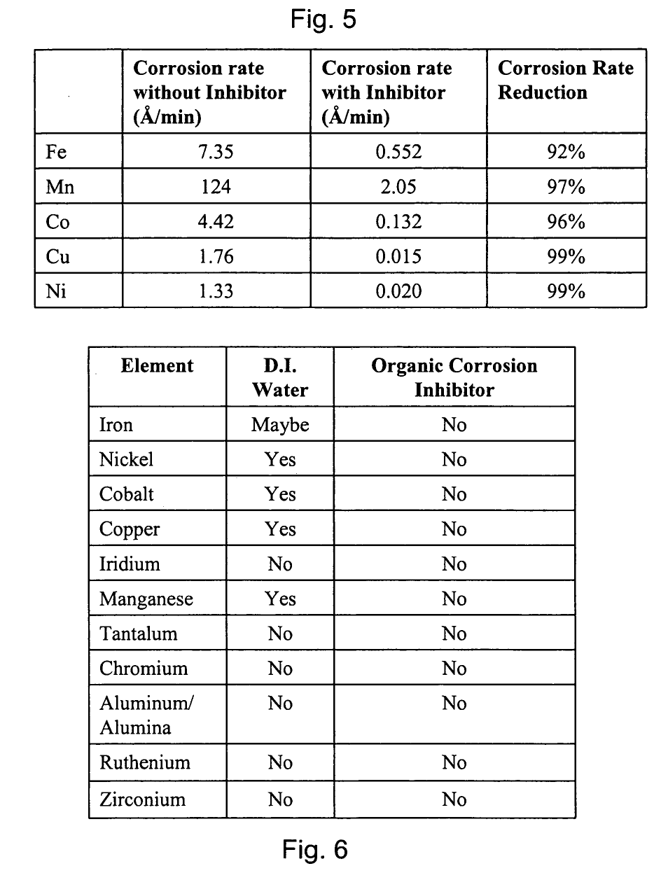

Indeed, the use of azole organic corrosion inhibitors with and without oxidizing agents has been shown by the inventor to reduce the rate of corrosion for even the most reactive magnetoresistive stack metals and alloys (e.g., manganese) by more than 91% (See summary of data, FIGS. 5 and 6). Organic coatings are also more reliable and more robust then other oxidation or passivation techniques.

The inhibitors of the invention are thought to act by adsorbing onto the metal surface, thus providing a barrier to the corrosive environment. Accordingly, some of the advantages of the present corrosion inhibitors include: (1) Presence of inhibitor film prevents uniform corrosion attack; (2) Organic inhibitors increase the activation energy on the metal surface (passivation); (3) Organic inhibitors have been shown to eliminate corrosion over wide range of pH values; and (4) Inhibitors adsorb and form a thin polymeric layer.

Many of the metals used for the MR, GMR, CMR and TMR sensors passivate at high pH values. However the degree to which each metal passivates and eliminates corrosion is dependent upon the metals ability to truly passivate. Iron is a good example of a metal that readily forms an oxide layer, however the oxide layer is not continuous and therefore does not eliminate corrosion. In fact, for iron the corrosion rate can be more severe at higher pH values because the unprotected area can see higher localized corrosion or pitting.

With the use of organic corrosion inhibitors specially formulated for the transition metals, a uniform continuous protective coating has been demonstrated for all of the common materials used for producing MR, GMR, CMR, and TMR thin film heads (see FIG. 6). Thus, further advantages of organic corrosion inhibitors of the invention include: (1) High adsorption characteristics for the transition metals; (2) Independent of the lapping or cleaning chemistry; (3) Not pH dependent; and (4) Produces a robust and ongoing barrier coating. Not being pH dependent can also be thought of as allowing manufacturing processes to take place at a larger range of pH values. For example, copper CMP polishing typically is done around pH 4. However, the data storage industry does not like to process anything at lower pH values (less than 5) or at high pH values (greater than 10.5) because rates of corrosion increase at those pH levels.

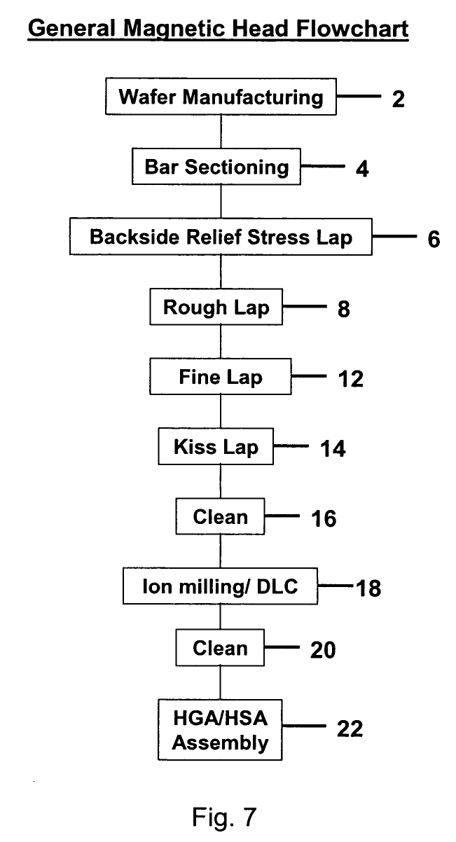

Turning to FIG. 7, the typical steps involved in a simplified process for magnetic head manufacturing is outlined. Indeed, many processes take place during the wafer manufacturing step 2, including cleaning and cutting processes to which an inhibitor composition of the invention may be added to inhibit corrosion. Likewise, the steps of bar sectioning 4 and backside relief stress lapping 6 both involve application of solutions to which addition of the invention would be useful. Rough lapping 8, fine lapping 12, and kiss lapping 14 are all preferred points at which compositions of the invention may be added to lapping solutions to inhibit corrosion. Moreover, the cleaning 16, ion milling 18, and cleaning 20 steps preferably also include cleaning solution or lubricating additives including inhibitor compositions of the invention. Once the assembly step 22 is complete, preferably a composition of the invention provides ongoing corrosion protection in the form of a lubricant additive.

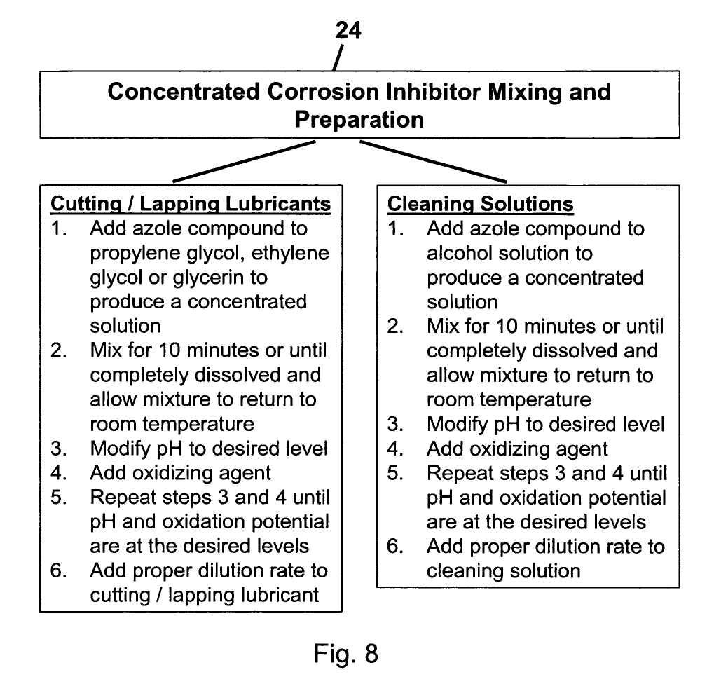

FIG. 8 outlines in flow chart form example 24 for the making of cutting/lapping and cleaning compositions of the invention. At least 1,000 parts per million (ppm) of azole compound has been found to be needed in the final inhibitor solution in order to be most effective for inhibiting manganese corrosion; 500 ppm to 5,000 ppm has been found to effectively inhibit corrosion for most of the other magnetic head device metals.

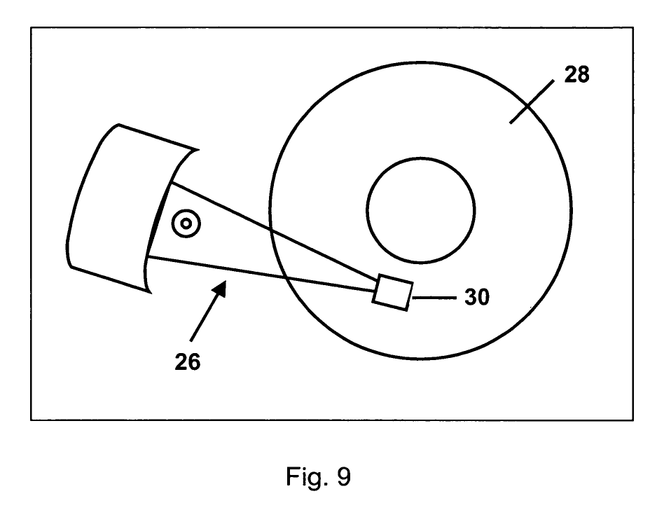

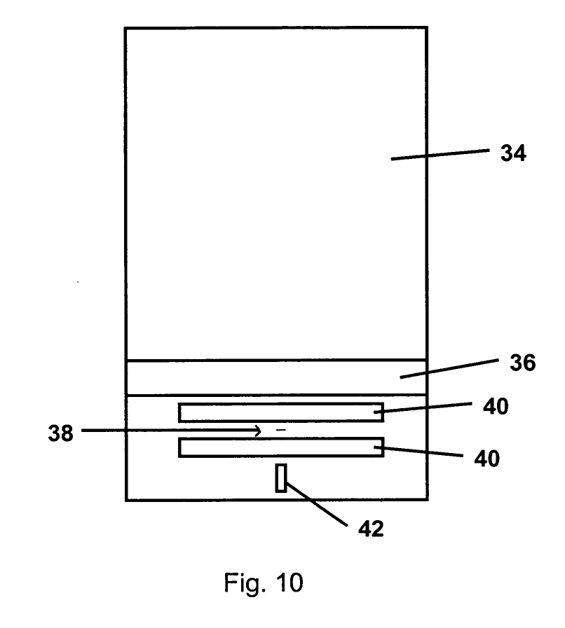

FIG. 9 illustrates in top plan view of a magnetic head read-write device 26 and magnetic media disk 28. A inhibitor composition of the invention is used to contact the relevant surfaces of the read-write head 30 or magnetic media 28 (including the backside). An enlarged view of the bottom of the magnetic head 30 as seen in FIG. 10 shows the air bearing surface (ABS) 34, undercoat 36, magnetoresistive reading stack 38, shared poles 40, and top writing pole 42. By contacting a layer or layers of magnetic material in the reading stack 38 with a composition of the invention during practically any point in the manufacturing process (or post-manufacturing), inhibition of corrosion is achieved.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products. All references cited in this application are hereby incorporated by reference herein.

What is claimed is:

1. A method for inhibiting corrosion on a magnetic head read-write device, comprising the steps of:
(a) providing a solution comprising at least one azole compound in an amount effective to inhibit corrosion; and
(b) contacting said solution of step (a) with the magnetic head read-write device.

2. The method of claim 1, wherein said at least one azole compound is selected from the group consisting of one or more of benzotriazole, tolyltriazole, 5-methyl-1,2,3-benzotriazole, 5-hexyl-1,2,3-benzotriazole, 5-oxtyl-1,2,3-benzotriazole, 5-methoxy-1,2,3-benzotrazole, 5(pridinethoxycarbonyl)-1,2,3-benzotriazole chloride, 2-chlorethyl-1,2,3-benzotrazole-5-carboxylate, 5-mercapto-1-phenyletrazole, 5-hydrocarbyl-2-metcapto-1,3,4-oxadiazole, aminotriazole, thiazoles, mercaptobenzotriazole, and 5-methyl-1-benzotriazole.

3. The method of claim 1, wherein said at least one azole compound is solvated by at least one solvent selected from the group consisting of ethylene glycol, propylene glycol, glycerin, and isopropal alcohol.

4. A corrosion inhibitor, comprising:
a composition including a non-aqueous solvent and at least one azole compound present in an amount effective to inhibit corrosion of a magnetic metal.

5. The corrosion inhibitor of claim 4, wherein said at least one azole compound is selected from the group consisting of one or more of benzotriazole, tolyltriazole, 5-methyl-1,2,3-benzotriazole, 5-hexyl-1,2,3-benzotriazole, 5-oxtyl-1,2,3-benzotriazole, 5-methoxy-1,2,3-benzotrazole, 5(pridinethoxycarbonyl)-1,2,3-benzotriazole chloride, 2-chlorethyl-1,2,3-benzotrazole-5-carboxylate, 5-mercapto-1-phenyletrazole, 5-hydrocarbyl-2-metcapto-1,3,4-oxadiazole, aminotriazole, thiazoles, mercaptobenzotriazole, and 5-methyl-1-benzotriazole.

6. The corrosion inhibitor of claim 4, wherein said at least one azole compound is present in an amount of at least 500 parts per million.

7. The corrosion inhibitor of claim 4, wherein said composition has a pH of between 2 and 12.

8. The corrosion inhibitor of claim 4, further containing one or more of an oxidizing agent selected from the group consisting of hydrogen peroxide and benzol peroxide.

9. The corrosion inhibitor of claim 8, wherein said oxidizing agent is present in a range of 500 parts per million to 10,000 parts per million.

10. A magnetic head read-write device, comprising:
a fully assembled magnetic head read-write device; and
a corrosion inhibitor including at least one azole compound disposed upon said magnetic head.

11. The magnetic head read-write device of claim 10, wherein said at least one azole compound is selected from the group consisting of one or more of benzotriazole, tolyltriazole, 5-methyl-1,2,3-benzotriazole, 5-hexyl-1,2,3-benzotriazole, 5-oxtyl-1,2,3-benzotriazole, 5-methoxy-1,2,3-benzotrazole, 5(pridinethoxycarbonyl)-1,2,3-benzotriazole chloride, 2-chlorethyl-1,2,3-benzotrazole-5-carboxylate, 5-mercapto-1-phenyletrazole, 5-hydrocarbyl-2-metcapto-1,3,4-oxadiazole, aminotriazole, thiazoles, mercaptobenzotriazole, and 5-methyl-1-benzotriazole.

12. The magnetic head read-write device of claim 10, wherein said at least one azole compound is present in an amount of at least 500 parts per million.

13. The magnetic head read-write device of claim 10, wherein said corrosion inhibitor has a pH of between 2 and 12 and is a lubricant additive.

14. A method for reducing a rate of corrosion of a magnetic metal or alloy deposited in a thin film layer, comprising the steps of:
(a) providing a solution comprising at least one azole compound in an amount effective to inhibit corrosion; and
(b) contacting said solution of step (a) with said thin film layer.

15. The method of claim 14, wherein said step of contacting the solution with the thin film layer occurs during a lapping, polishing, lubricating, cutting, or cleaning process performed during wafer manufacturing.

16. The method of claim 14, wherein said thin film layer contains a metal, or an alloy including a metal, that is selected from the group consisting of one or more of iron, nickel, manganese and cobalt.

17. The method of claim 14, wherein said corrosion rate is reduced at least 92%.

18. The method of claim 14, wherein said thin film layer is disposed upon a magnetic storage media.

19. The method of claim 18, wherein said magnetic storage media includes a metal, or an alloy containing a metal, selected from the group consisting of one or more of iron, nickel, cobalt, and manganese.

20. The method of claim 14, wherein said at least one azole compound is selected from the group consisting of one or more of benzotriazole, tolyltriazole, 5-methyl-1,2,3-benzotriazole, 5-hexyl-1,2,3-benzotriazole, 5-oxtyl-1,2,3-benzotriazole, 5-methoxy-1,2,3-benzotrazole, 5(pridinethoxycarbonyl)-1,2,3-benzotriazole chloride, 2-chlorethyl-1,2,3-benzotrazole-5-carboxylate, 5-mercapto-1-phenyletrazole, 5-hydrocarbyl-2-metcapto-1,3,4-oxadiazole, aminotriazole, thiazoles, mercaptobenzotriazole, and 5-methyl-1-benzotriazole.

21. A method for inhibiting corrosion of a manganese- or cobalt-containing magnetic head read-write device, comprising the steps of:
a) providing a solution comprising at least one azole compound in an amount of at least 1000 parts per million; and
(b) contacting said solution of step (a) with said manganese- or cobalt-containing magnetic head read-write device.
